(19) United States
(12) Patent Application Publication
(10) Pub. No.: US 2007/0278029 A1
(43) Pub. Date: Dec. 6, 2007

(54) HYBRID DRIVE SYSTEM

(75) Inventors: Masataka Sugiyama, Toyota-shi (JP); Nobuyuki Nagashima, Toyota-shi (JP); Masatoshi Adachi, Nishikamo-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/757,072

(22) Filed: Jun. 1, 2007

(30) Foreign Application Priority Data
Jun. 2, 2006 (JP) 2006-155048

(51) Int. Cl. B60K 6/00

(52) U.S. Cl. 180/300; 180/65.2; 903/904

(57) ABSTRACT

A hybrid drive system is provided which includes a first damper that is connected to an output shaft of an engine; an electric motor which is provided adjacent to the first damper and connected to the output side of the first damper; a power split device that distributes power from the engine to the electric motor and a wheel side output shaft; and a second damper that is connected to the output side of the first damper between the first damper and the electric motor. Accordingly, a hybrid drive system can be provided which reduces vibration caused by resonance of a torsional damper without increasing the size of the hybrid drive system.

### INCORPORATION BY REFERENCE

The disclosure of Japanese Patent Application No. 2006-155048 filed on Jun. 2, 2006, including the specification, drawings and abstract is incorporated herein by reference in its entirety.

### BACKGROUND OF THE INVENTION

1. Field of the Invention

The invention relates to a hybrid drive system that includes an engine and a motor-generator as drive sources. More particularly, the invention relates to a hybrid drive system that reduces resonance and gear rattling when the engine is started and stopped.

2. Description of the Related Art

A hybrid drive system which is used as a drive system for a vehicle such as a passenger automobile is known which includes an engine that operates by burning fuel, a first motor-generator, a planetary gear set in which one of a sun gear and a carrier is connected to the engine while the other is connected to the first motor generator and a ring gear is connected to an output member, and a second motor-generator that is connected to the output member. One such hybrid drive system described in Japanese Patent Application Publication No. JP-A-9-226392 reduces vibration produced in the drive system by absorbing return vibration caused by torque fluctuation while the engine is being driven using a torsional damper that is connected to an output shaft of the engine.

The output side of this kind of torsional damper is connected to an electric motor via the planetary gear set. Because the mass of the rotor of the electric motor is large, however, the resonant frequency of the torsional damper is by nature low so vibration increases when there is resonance. In particular, the hybrid drive system tends to resonate because the engine is frequently started and stopped in this kind of system. As a result, vibration from the engine is transmitted to the gears of the planetary gear set which induces gear rattling. While it is possible to suppress this gear rattling by providing a dynamic damper that reduces vibration caused by that resonance, doing so also increases the size of the drive system.

### SUMMARY OF THE INVENTION

In view of the foregoing problems, this invention thus provides a hybrid drive system that reduces vibration caused by resonance of a torsional damper without increasing the size of the hybrid drive system.

Thus, a first aspect of the invention relates to a hybrid drive system that includes a first damper that is connected to an output shaft of an engine; an electric motor which is provided adjacent to the first damper and connected to an output side of the first damper; a power split device that distributes power from the engine to the electric motor and a wheel side output shaft; and a second damper that is connected to the output side of the first damper between the first damper and the electric motor.

According to the hybrid drive system described above, an empty space is formed between the first damper and the inner peripheral portion of the electric motor. By arranging the second damper in this empty space, the second damper is able to be provided without increasing the size of the hybrid drive system.

Further, in the foregoing hybrid drive system, the first damper may be a torsional damper, the second damper may be a dynamic damper, and this dynamic damper may be set to reduce a peak of a gain of a resonance frequency of the torsional damper.

According to the hybrid drive system having this kind of structure, the dynamic damper which is the second damper absorbs vibration, thus enabling vibration caused by resonance of the torsional damper which is the first damper to be reduced.

### BRIEF DESCRIPTION OF THE DRAWINGS

The features, advantages thereof, and technical and industrial significance of this invention will be better understood by reading the following detailed description of preferred embodiments of the invention, when considered in connection with the accompanying drawings, in which:

FIG. 1 is a skeleton view of a hybrid drive system to which one example embodiment of the invention has been applied;

FIG. 2 is a sectional view of a damper device shown in FIG. 1;

FIG. 3 is a conceptual diagram of a damper device for suppressing vibration of the hybrid drive system according to this example embodiment; and

FIG. 4 is a graph illustrating the relationship between the frequency and magnitude of vibration of the hybrid drive system according to this example embodiment.

### DETAILED DESCRIPTION OF THE PREFERRED EMBODIMENTS

In the following description and the accompanying drawings, the present invention will be described in more detail in terms of exemplary embodiments.

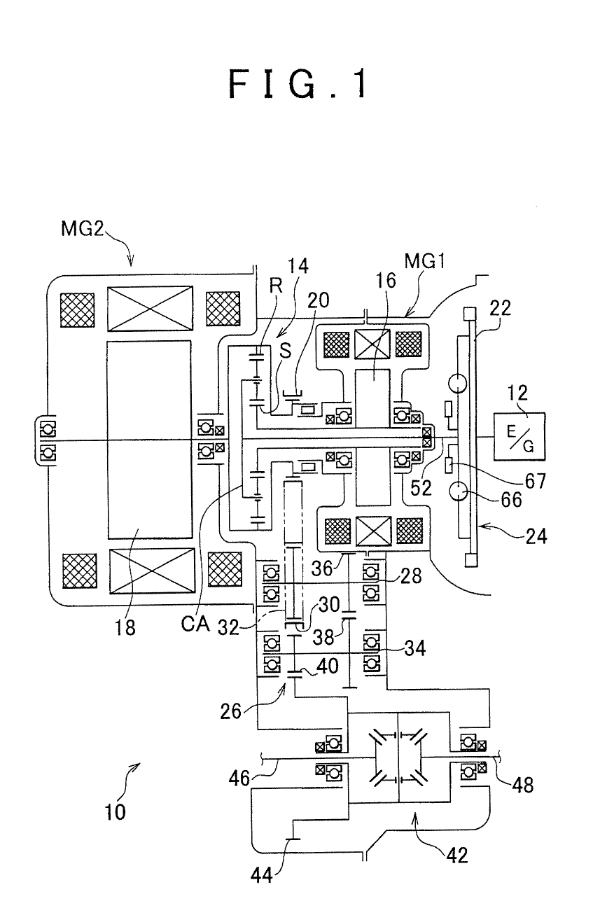

FIG. 1 is a skeleton view of a hybrid drive system 10 to which the invention has been applied. This hybrid drive system 10 is a FF (front engine, front drive) system, i.e., a transverse mounted system in which the rotating shaft is arranged substantially parallel to the width direction of the vehicle. This hybrid drive system 10 includes an engine 12 such as an internal combustion engine that operates by burning fuel, a first electric motor MG1, a single pinion type planetary gear set 14, and a second electric motor MG2. The planetary gear set 14 has a carrier CA, a sun gear S, and a ring gear R. The carrier CA is connected to the engine 12 and serves to mechanically distribute the power from the engine 12 to the first electric motor MG1 and a wheel side output shaft. The sun gear S is connected to a rotor 16 of the first electric motor MG1. The ring gear R is connected to both a rotor 18 of the second electric motor MG2 and a sprocket 20 that serves as an output member. This planetary gear set 14 mainly distributes power transmitted from the engine 12 to the first electric motor MG1 and the sprocket 20. The first electric motor MG1 is mainly used as a generator and charges a power storing device such as a battery with electric energy that has been generated by the first electric motor MG1 being rotatably driven by the engine 12 via the planetary gear set 14. The second electric motor MG2, on the other hand, is used mainly as a drive motor which is used as a driving source for the vehicle either independently or in conjunction with the engine 12. This second electric motor MG2 requires a large amount of torque and is therefore larger than the first electric motor MG1. Incidentally, the first electric motor MG1 may also be used as a drive motor when starting the engine or running at high speeds, and the second electric motor MG2 may also be used as a generator when the vehicle is decelerating. Here, the output from the engine 12 is transmitted to the planetary gear set 14 via a flywheel 22 for suppressing fluctuations in rotation and torque, and a damper device 24 that includes a torsional damper 66 and a dynamic damper 67. Incidentally, the planetary gear set 14 of this example embodiment corresponds to a power split device of the invention.

The sprocket 20 is connected via a chain 32 to a driven sprocket 30 provided on a first intermediate shaft 28 of a reduction mechanism 26. The reduction mechanism 26 also includes a second intermediate shaft 34 which is parallel to the first intermediate shaft 28, and both slows rotation using a pair of reduction gears 36 and 38 that are in mesh with each other and transmits power from an output gear 40 provided on the second intermediate shaft 34 to an umbrella gear type differential gear unit 42. The output gear 40 is in mesh with a large diameter ring gear 44 which serves as an input member of the differential gear unit 42. This ring gear 44 rotates even slower and power is distributed to left and right driving wheels via a pair of output shafts 46 and 48.

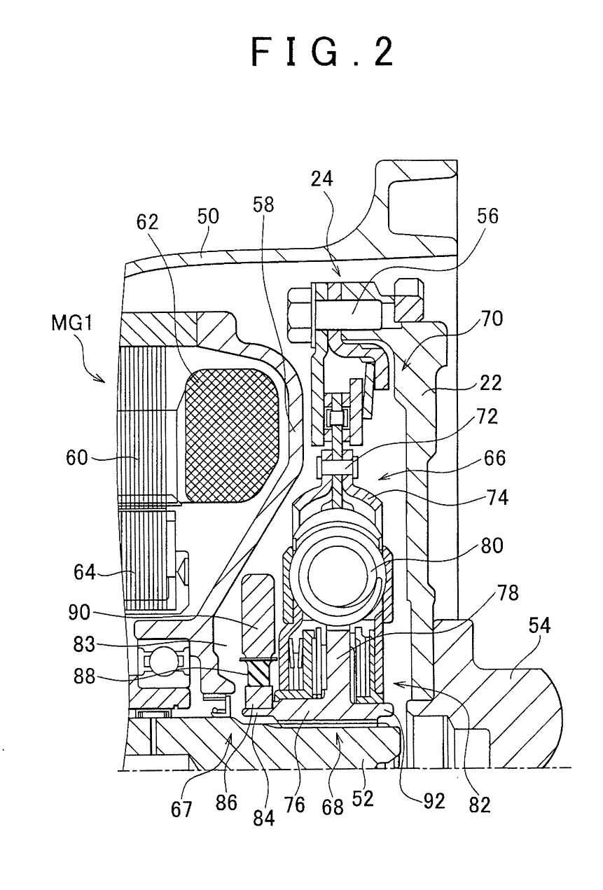

FIG. 2 is a sectional view illustrating the structure of the damper device 24 shown in FIG. 1. The damper device 24 is interposed between the first electric motor MG1 which is arranged in a case 50 which is a non-rotating member and the flywheel 22, and is positioned concentric with an input shaft 52 that is connected to the carrier CA of the planetary gear set 14. Incidentally, the first electric motor MG1 in the example embodiment corresponds to an electric motor of the invention.

The flywheel 22 is a disc-shaped member which is connected at an inner peripheral edge by press-fitting or the like to a crankshaft 54 that is connected to the engine 12. Meanwhile, an outer peripheral edge of the flywheel 22 is connected by a bolt 56 to an outer peripheral side of the damper device 24.

The first electric motor MG1 is adjacent to the damper device 24 on the other side of a case wall 58, i.e., the case wall 58 is sandwiched between the first electric motor MG1 and the damper device 24. The first electric motor MG1 includes a stator 60 that is non-rotatably fixed to the case wall 58, a stator coil 62 which is wound around the stator 60 and protrudes in the axial direction, and a rotor 64 which is positioned on the inner peripheral side of the stator 60 and connected to the sun gear S of the planetary gear unit 14 and thus rotates integrally with the sun gear S.

The damper device 24 includes two dampers, i.e., the torsional damper 66 and the dynamic damper 67. The torsional damper 66 is formed of an input side member 70 which is connected to the engine 12 and inputs power from the engine 12, and an output side member 68 which forms the output side of the torsional damper 66. The input side member 70 is connected by the bolt 56 to the flywheel 22 to which the output of the engine 12 is transmitted via the crankshaft 54, and is also connected to a drive plate 74 by a pin 72. The output side member 68 includes a base portion 76 that is spline-engaged at the inner peripheral surface to an input shaft 52, and a flange portion 78 that protrudes from the outer peripheral surface of the base portion 76 in the radial direction. A coil-shaped spring 80 and a friction mechanism 82 are interposed between the output side member 68 and the input side member 70. The coil-shaped spring 80 allows relative rotation between the input side member 70 and the output side member 68 according to elastic deformation. The friction mechanism 82 includes a plurality of friction elements that are stacked in the axial direction squeezed between the output side member 68 and the input side member 70. The coil-shaped spring 80 and the friction mechanism 82 absorb vibration caused by fluctuations in torque and rotation from the engine 12, thereby reducing the vibration transmitted to the output side. Incidentally, the torsional damper 66 in this example embodiment corresponds to a first damper of the invention and the dynamic damper 67 corresponds to a second damper of the invention.

Also, the stator coil 62 of the first electric motor MG1 protrudes in the axial direction so an annular space 83 is formed between the inner peripheral side of the stator coil 62 of the first electric motor MG1 and the torsional damper 66, and the dynamic damper 67 is arranged in that annular space 83.

The dynamic damper 67 is integrally formed on a cylindrical first extended portion 84 that extends in the axial direction from the base portion 76 to the first electric motor MG1 side by being press-fit into the outer peripheral side of the first extended portion 84. Also, the dynamic damper 67 includes a damper base portion 86 that is press-fit into the outer peripheral surface of the first extended portion 84, a bush portion 88 that is connected to the outer periphery of that damper base portion 86, and a mass portion 90 that is connected to the outer periphery of the bush portion 88. The damper base portion 86 is fitted to the first extended portion 84 by press-fitting so as not to be able to rotate relative to that first extended portion 84. Also, the bush portion 88 is formed by an elastic member such as rubber, for example, and is thus able to rotate a small amount with respect to the damper base portion 86 due to the elasticity of the bush portion 88. The mass portion 90 is a member that has a predetermined mass such as an iron member, for example. This mass portion 90 vibrates in the direction of rotation from the elasticity of the bush portion 88. Further, a second extended portion 92 that extends in the axial direction is provided on the other end in the axial direction of the base portion 76, i.e., the end of the base portion 76 opposite the end on which the first extended portion 84 is provided. This second extended portion 92 is provided to receive the excessive load that is applied from press-fitting when the dynamic damper 67 is assembled after the torsional damper 66 is assembled. As a result, excessive load is prevented from being applied to the friction elements of the friction mechanism 82 during press-fitting so adverse effects such as deformation of the friction plates caused by pressure can be suppressed.

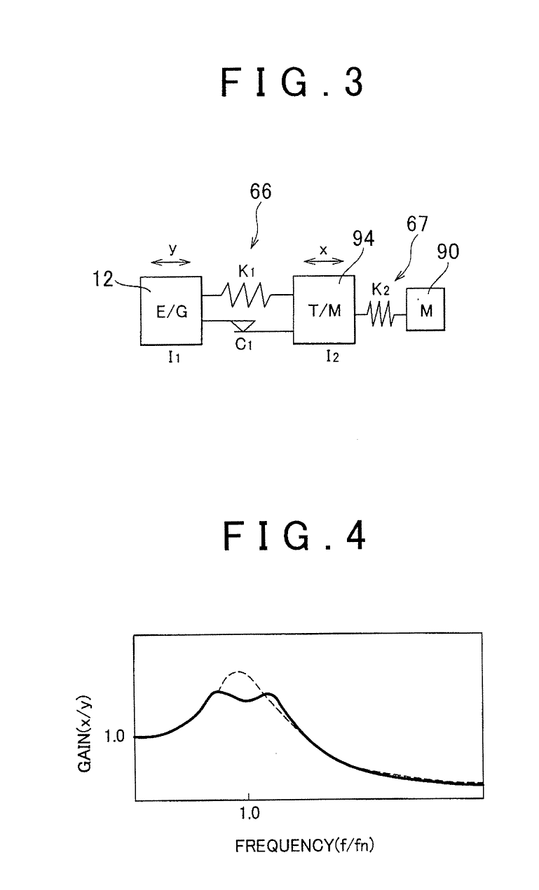

FIG. 3 is a conceptual diagram of the damper device for suppressing vibration of the hybrid drive system 10 of this invention. In the drawing, K1 and C1 between the engine 12 and a transmission 94 which is on the output side represent the torsional rigidity and the damping coefficient of the torsional damper 66, and K2 between the transmission 94 and the mass portion 90 represents the torsional rigidity of the dynamic damper 67. An inertia moment I1 on the engine 12 side is connected to the flywheel 22 and the like so the relative inertia moment increases, while the inertia moment I2 on the transmission 94 side is connected to the rotor 16 of the first electric motor MG1 and the like so the relative inertia moment increases. Here, a resonance frequency fn of the torsional damper 66 is mainly controlled by the inertia moments I1 and I2 and is inversely proportionate to the magnitudes of these inertia moments I1 and I2. As a result, the resonance frequency fn of the torsional damper 66 is a relatively low value. This resonance frequency fn resembles the frequency when the engine 12 is being started or stopped. When the dynamic damper 67 is not provided, the characteristic of the resonance frequency fn is as shown by the broken line in FIG. 4 which is a graph illustrating the relationship between the frequency and the magnitude of the vibration. The horizontal axis in the drawing represents the frequency which has been made dimensionless by the resonance frequency fn of the torsional damper 66. The vertical axis in the drawing represents the gain of the amplitude x of the vibration that is output to the transmission 94 by the amplitude y of the vibration that is transmitted from the engine 12. When this gain increases, so does the vibration. As shown by the broken line, when the dynamic damper 67 is not provided, resonance occurs when the frequency f is near the resonance frequency fn (near 1.0 in the drawing), at which point vibration increases.

The dynamic damper 67 is adjusted so that it vibrates at the same frequency as the resonance frequency fn of the torsional damper 66. When this dynamic damper 67 is connected, the peak of the gain produced near the resonance frequency fn decreases, as shown by the solid line in FIG. 4. That is, this dynamic damper 67 absorbs the vibration of the torsional damper 66 so that the vibration that is transmitted to the input shaft 52 is reduced. Incidentally, the frequency characteristics of the dynamic damper 67 can be adjusted by changing the torsional rigidity K2 of the bush portion 88 and the mass M of the mass portion 90.

As described above, according to this example embodiment, an open space is formed between the torsional damper 66 and the inner peripheral portion of the first electric motor MG1. By arranging the dynamic damper 67 in this open space, the dynamic damper 67 can be provided without increasing the size of the hybrid drive system 10.

Also according to this example embodiment, by providing the dynamic damper 67 and matching the frequency characteristics of this dynamic damper 67 with the resonance frequency fn of the torsional damper 66, the dynamic damper 67 can absorb the vibration, thus reducing the vibration caused by resonance. As a result, vibration that is transmitted to the input shaft 52 can be reduced, thereby suppressing gear rattling.

Further, according to this example embodiment, the dynamic damper 67 is provided integrally on the first extended portion 84 that extends in the axial direction from the base portion 76 of the torsional damper 66, which keeps these structures from becoming complex. Also, providing the first extended portion 84 enables changes in the manufacturing process to be kept to a minimum, with only the process of assembling the dynamic damper 67 being added to the end of the manufacturing process of the torsional damper 66.

Also according to this example embodiment, the second extended portion 92 is provided on the end of the base portion 76 that is opposite the end on which the first extended portion 84 of the torsional damper 66 is provided. As a result, when the dynamic damper 67 is press-fit into the first extended portion 84 during assembly, the second extended portion 92 receives the press-fitting load during press-fitting so that assembly can be performed without an excessive load being applied to the friction elements that are arranged on the inner peripheral portion.

Also according to this example embodiment, the dynamic damper 67 has a simple structure so the frequency setting can also be easily adjusted.

Further, according to this example embodiment, the stator coil 62 protrudes in the axial direction. As a result, an annular space 83 is formed on the inner peripheral side of the stator coil 62. By arranging the dynamic damper 67 in this annular space 83, the dynamic damper 67 is able to be provided without increasing the size of the drive system.

While example embodiments of the invention have been described in detail with reference to the drawings, the invention is not limited to these exemplary embodiments or constructions.

For example, the bush portion 88 of the dynamic damper 67 is made of rubber. Alternatively, however, it may also be made of metal material having elasticity such as a spring or may be realized using other elasticity such as a hydraulic piston or a pneumatic piston or the like.

Further, the mass portion 90 of the dynamic damper 67 is made of iron but is not limited thereto as long as it has a mass that can be adjusted to the resonance frequency fn of the torsional damper 66.

Moreover, the hybrid drive system 10 of this example embodiment is a FF type drive system. However, the hybrid drive system 10 is not particularly limited to an FF type drive system, but may also be applied to another type of drive system such as an FR type drive system.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A hybrid drive system comprising:
a first damper that is connected to an output shaft of an engine;
an electric motor which is provided adjacent to the first damper and connected to an output side of the first damper;
a power split device that distributes power from the engine to the electric motor and a wheel side output shaft; and
a second damper that is connected to the output side of the first damper between the first damper and the electric motor.

2. The hybrid drive system according to claim 1, wherein the first damper is a torsional damper, the second damper is a dynamic damper, and the dynamic damper is set to reduce a peak of a gain of a resonance frequency of the torsional damper.

3. The hybrid drive system according to claim 2, wherein the torsional damper includes an input side member into which the power from the engine is input, an output side member that forms an output side of the torsional damper, and a spring that allows relative rotation between the input side member and the output side member according to elastic deformation, and the dynamic damper is provided on a first extended portion that extends in an axial direction from one end of the output side member to the electric motor side.

4. The hybrid drive system according to claim 3, wherein the torsional damper includes a plurality of friction elements stacked in the axial direction and sandwiched between the input side member and the output side member, and a second extended portion that extends in the axial direction from the other end of the output side member, which is the end opposite the end on which the first extended portion is provided.

5. The hybrid drive system according to claim 4, wherein the dynamic damper includes a damper base portion provided on the first extended portion in a manner non-rotatable with respect to the first extended portion, and a mass portion having a predetermined mass provided via a bush portion made of elastic material on an outer peripheral side of the damper base portion.

6. The hybrid drive system according to claim 3, wherein the dynamic damper includes a damper base portion provided on the first extended portion in a manner non-rotatable with respect to the first extended portion, and a mass portion having a predetermined mass provided via a bush portion made of elastic material on an outer peripheral side of the damper base portion.

7. The hybrid drive system according to claim 3, wherein the electric motor includes a stator that is fixed to a case and a stator coil that protrudes in the axial direction from the stator, and the dynamic damper is positioned in an annular space formed on an inner peripheral side of the stator coil.

8. The hybrid drive system according to claim 2, wherein the electric motor includes a stator that is fixed to a case and a stator coil that protrudes in the axial direction from the stator, and the dynamic damper is positioned in an annular space formed on an inner peripheral side of the stator coil.
